(19) United States
(12) Patent Application Publication
(10) Pub. No.: US 2023/0100387 A1
(43) Pub. Date: Mar. 30, 2023

(54) APPARATUS AND METHOD FOR FORMING PLASTICS PREFORMS WITH CONTROLLED VALVE UNIT

(71) Applicant: KRONES AG, Neutraubling (DE)

(72) Inventors: Andreas BRUNNER, Aufhausen (DE); Thomas HOELLRIEGL, Teublitz (DE)

(21) Appl. No.: 17/942,946

(22) Filed: Sep. 12, 2022

(30) Foreign Application Priority Data
Sep. 28, 2021 (DE) 10 2021 125 052.8

(51) Int. Cl. B29C 49/42; B29C 49/78

(52) U.S. Cl. CPC B29C 49/4289; B29C 49/42065; B29C 49/783; B29C 2049/7831; B29C 2049/78805; B29L 2031/7158

(57) ABSTRACT

A method for forming plastic preforms into plastic containers, wherein the plastic preforms being transported along a predetermined transport path and being acted upon and expanded by a flowable medium during this transport, a controllable valve of a reducing station controlling the action of the flowable medium on a compressed-air reservoir, in particular an annular channel, and a desired target pressure being predetermined, with which the compressed-air reservoir is acted upon, this desired target pressure being taken into account in the control of the valve of the reducing station wherein an actual pressure is determined and this actual pressure is compared with the desired target pressure and, from this comparison, a correction value is determined which is taken into account and/or used in the control of the valve.

### BACKGROUND OF THE INVENTION

The present invention relates to a method and an apparatus for forming plastic preforms into plastic containers. In the beverage manufacturing industry, it has long been known that plastic preforms are first heated and then formed into plastic containers, such as plastic bottles, by applying compressed air.

Different recipes are used to produce the plastic bottles. When creating a bottle recipe, the pressures, especially blowing pressures, are set on an operating unit such as a touch screen. The machine control translates these parameters into electrical setpoints (4-20 mA) and forwards them to the corresponding valves. The valve translates the electrical signal into a pneumatic pressure, the control pressure for a dome pressure regulator.

The dome pressure regulator regulates the primary pressure, for example 35 bar, down to a secondary pressure, for example 25 bar, and feeds this into an annular channel. This annular channel is in turn connected to the valve blocks at each forming station.

If compressed air is needed to blow the bottle, the valve block opens the respective blow valves and air flows out of the annular channel into the containers. The pressure in the annular channel drops or collapses briefly due to the withdrawal before the dome pressure regulator can equalise the pressure again or reacts to it.

Due to the large number of components involved, there is a control tolerance, i.e. a deviation between the target pressure and the actual pressure. Depending on the technical condition of the valve and the dome pressure regulator, this can be up to 4 bar. Furthermore, deviations of different sizes occur in a compressed air reservoir, for example in the annular channel, due to different air requirements.

Factory-new valves, for example, have higher internal friction, greater control tolerances and reaction times than “run-in” valves. The control tolerance of dome-loaded pressure regulators varies greatly with the level of the setpoint. With a low setpoint, for example 5 bar, the deviation is much higher than with a setpoint of 30 bar.

In addition, the valve or the dome pressure regulator are not actively readjusted. In the event of a brief strong demand for air, the pressure drops more strongly for a short time before the pressure regulator reacts to this and readjusts the pressure. The pressure level also fluctuates more strongly in the event of disruptive influences such as bottle bursts and has a greater effect on the quality of the blown bottles (because of the material distribution). The material distribution of the container is primarily determined by the pressure increase in the container for the movement of the stretching rod, thus this also varies strongly with fluctuations in the pressure.

### SUMMARY OF THE INVENTION

An object of the present invention is therefore achieving the task of compensating for such control tolerances or preventing them.

In a method according to the invention for forming plastic preforms into plastic containers, the plastic preforms are transported along a predetermined transport path and, during this transport, are acted upon by a flowable medium and, in particular, a gaseous medium (and, in particular, compressed air) and are expanded in this way, wherein a controllable valve (and in particular a controllable valve of a reducing station) controls the admission of the flowable medium to a compressed air reservoir, in particular an annular channel, and wherein a target pressure is predetermined with which the compressed air reservoir is admitted, wherein this target pressure or a target value of this target pressure is determined at the time of the admission of the flowable medium.

According to the invention, an actual pressure is determined and this actual pressure is compared with the target pressure and from this comparison a correction value is determined and/or calculated, which is taken into account and/or used in the control of the valve (the reducing station) and/or the valve is controlled taking into account this or as a function of this actual pressure(s).

It is thus proposed that an actual pressure, in particular an instantaneous actual pressure, in particular an actual pressure within the pressure reservoir is determined (in particular with a pressure transducer) and compared with the target pressure. A corresponding control of the valve can be derived from this comparison.

Preferably, the fluid medium is compressed air. However, expansion with a liquid medium, for example with a product to be filled, would also be conceivable.

Preferably, the above-mentioned valve is therefore assigned to the reducing station. The (at least one) valve is preferably part of this reducing station and preferably controls it. As mentioned above, the reducing station serves to reduce a primary pressure to a secondary pressure used by the device. Preferably, said valve is arranged upstream of the reducing station in the direction of flow of the flowable medium and/or it is a component of this reducing station. Preferably, this valve of the reducing station is a central valve, which is not assigned to a specific forming station, but influences the supply of compressed air to the reservoir.

In a preferred embodiment, the actual pressure is determined continuously during the expansion process. However, it would also be conceivable that the actual pressure is determined at predetermined times during the expansion process.

In another preferred embodiment, the containers are stretched in their longitudinal direction by means of a stretching bar. This stretching bar is inserted into the interior of the plastic preforms. Particularly preferably, the plastic preforms are formed into the containers within blow moulds.

In a further preferred embodiment, the valve is controlled. Preferably, a corresponding device for forming plastic preforms into plastic containers has a movable and in particular a rotatable carrier, in particular a so-called blowing wheel, on which a plurality of forming stations are arranged.

In another preferred embodiment, a target pressure is specified by a user, for example via an operating device such as a touchpad. However, it would also be conceivable for the target pressure to be specified by a machine controller, for example on the basis of a bottle recipe with which the plastic preforms are to be expanded.

In a preferred embodiment, the correction value results from a difference between the actual pressure and the target pressure. In this way, the valve can be controlled taking this difference into account. Preferably, an offset is calculated from these values or the difference, which is taken into account when controlling the valve. This offset can be calculated time-dependently and can also be taken into account.

By means of the difference between the actual pressure (which is determined, for example, by means of a pressure transducer) and the target pressure (which is specified, for example, via an operating device or a touchpad), an offset can be calculated and/or actively counteracted by a control device, in particular an electronic control device.

Preferably, this offset is calculated with the entered target value at the operating device and forwarded to the valve. Advantageously, the valve is a proportional valve.

In another preferred embodiment, the control device knows when the individual blow valves of the valve blocks at the forming stations are opened and controlled and thus it is possible to counteract in advance with a defined period of time and also a necessary pressure increase in the reducing station (by means of a corresponding control of the valve of the reducing station).

Preferably, the aforementioned blowing valves are assigned to the individual forming stations, while the aforementioned valve is assigned to the reducing station.

In a further preferred embodiment, the proportional valve and/or a reducing station such as a dome pressure regulator is controlled to the calculated target value. In this way, the desired target pressure can be maintained in a compressed air reservoir such as an annular channel.

Another possibility arises when instead of or in addition to a pressure transducer in the compressed air reservoir such as a annular channel, a pressure transducer in the individual valve blocks is used to form the offset. In another approach, the duration and also the pressure increase are determined via a control loop. Here, as described in more detail below, it is possible to provide an AI function in the control device or a higher-level control device. In this way, the determination of the necessary process parameters can be provided or supported.

It would thus be possible for the actual pressures to be recorded and stored, especially over a longer period of time. In particular, the recording and storage can be carried out with an assignment to the respective forming station. Furthermore, these pressure values can be related to further data relating to the valves, such as a manufacturer of the valves, a service life of the valves and the like. By evaluating this data, a remaining service life of the valves can be predicted for the future, for example.

A corresponding counter-reaction can also be initiated on the basis of a large number of recorded data (in particular the above-mentioned blow valves, which are assigned to the individual forming stations), for example the time for opening or closing the blow valves can be changed. In addition, measured values such as target pressures can also be recorded, and in this way it can be determined, for example by an AI, what effect a certain change has had.

In another preferred embodiment, further data relevant to the expansion process is also recorded, such as a position and speed of a stretching bar, or also a position of the relevant forming station along its transport path.

Since the above-mentioned parameters are usually only necessary once per bottle recipe, this can also be determined outside the machine control and then preferably stored in the process parameters of the machine control. In addition, it is also possible that these parameters are stored online, whereby a machine selects and/or changes these values from a database based on the machine and/or process parameters. By means of a pressure measuring device in a annular channel or in the valve blocks, all deviations can be detected (even those that do not occur regularly) and in this way, countermeasures can be taken immediately and/or compensated for in the best possible way by a control loop.

In addition, it would also be possible to change the switching times and the opening times of the blow valves as suitable countermeasures in the event of excessive pressure fluctuations in order to minimise the fluctuations in the storage facility. A constant container quality is the result to be achieved.

In another preferred embodiment, the control device may forward the offset parameters to a storage device. Thus, there could be an online connection to a predefined cloud and/or online site and/or system via which this data is forwarded. In this way, parameters can be controlled, monitored and evaluated over the entire life cycle and also across the board. It is thus possible to compare and optimise recipes of a container (bottle) from several machines and production sites worldwide in terms of container quality, energy consumption, output, etc.

In a preferred embodiment, limit values (such as for the target pressure) are defined. If these predefined limit values are exceeded, feedback can be given to the machine operator. In addition, required spare parts can be ordered automatically and planned maintenance can be requested. A message can also be sent to a line diagnostic system at a control station. In addition, it is also conceivable to change the switching times and the opening times of the blowing valves as suitable countermeasures in order to guarantee a constant container quality.

In a further preferred embodiment, taking into account the correction value, at least one time is determined at which valves are actuated and in particular at which the valve of the reducing station is actuated and in particular a time is determined at which the valves (and in particular the valve of the reducing station) switches between an open position and a closed position.

It is possible that a certain point in time is specified by a user or a controller and that this point in time is changed taking into account said correction value. In particular, the valves (and especially the valve of the reducing station) are controlled to change from a closed state to an open state or, conversely, to change from an open state to a closed state.

In a further preferred embodiment, a plurality of forming stations is provided for forming plastic preforms into plastic containers, wherein an actual pressure is determined for each of these forming stations, in particular by means of a measuring device. Particularly preferably, each of these forming stations has a valve block with at least one controllable blowing valve. Advantageously, each of these blowing valves is controlled individually, taking into account the actual pressure and/or the target pressure. Thus, these valves are preferably assigned to the respective forming station, whereby the above-mentioned valve is a valve assigned to the reducing station.

In another preferred embodiment, the forming stations are jointly supplied with compressed air by means of a compressed air reservoir, such as an annular channel. Particularly preferred is a plurality of reservoirs and especially a plurality of annular channels in which different pressure levels of the blowing air can be stored.

In a further advantageous embodiment, the plastic preforms are subjected to several pressure stages for their expansion, and preferably the actual pressure is determined for at least one of these pressure stages. Preferably, the actual pressure is determined for several of the pressure stages. Particularly preferably, the actual pressure is readjusted in response to the determined actual pressure.

In a further preferred embodiment, the plastic preforms are successively subjected to several pressure stages. Preferably, the plastic preforms are acts upon with at least two, preferably with at least three pressure stages. Particularly preferably, the pressures increase in the course of the expansion of the plastic preforms.

In a further preferred embodiment, the plastic preforms are first subjected to a pre-blowing pressure, then (directly or indirectly) to an intermediate blowing pressure (which is in particular higher than the pre-blowing pressure) and finally to a final blowing pressure (which is in particular higher than the intermediate blowing pressure). In addition, a further pressure stage can be provided between the pre-blowing pressure and the final blowing pressure.

A pressure measurement is preferably carried out at least once and particularly preferably at least once during the pressurisation in at least two of the pressure stages and preferably at least once per pressure stage.

In a further preferred embodiment, the above-mentioned valve, i.e. the valve assigned to the reducing station, is a proportional valve. In addition, it would also be conceivable that one or more of the valves assigned to the conversion stations are proportional valves.

In a further preferred embodiment, the pressurised flowable medium is made available via a compressed air source and, particularly preferably, the pressure originating from this compressed air source is reduced by a reducing station, in particular preferably the compressed air enters the compressed air reservoir. In particular, the reducing station is a dome pressure regulator. Particularly preferably, the compressed air source is a compressor, refrigeration dryer and/or line network or also a pressure connection, which may be present in a company, for example.

Preferably, the valve of the reducing station is (also) controlled on the basis of the actual pressure.

In another preferred embodiment, the actual pressure is determined by means of a pressure measuring device which is arranged in a compressed air reservoir. Alternatively or additionally, the actual pressure is determined by means of a plurality of pressure measuring devices, each of which is assigned to the individual forming stations.

In another preferred embodiment, the actual pressure is recorded continuously. This can be done over a predetermined period of time, for example, or also at the different pressure stages. In addition, a number of pressure transducers can also be provided for each forming station. These can record the pressures once or continuously.

In a further preferred embodiment, actual pressures, target pressures and/or correction values are preferably continuously recorded by means of an (electronic) memory device. These values can be used to control the valves. As mentioned above, this storage is preferably carried out with an assignment to the respective forming station.

In a further preferred embodiment, the respective values are permanently recorded and especially preferably also stored. In this way, the behaviour of a valve can be determined and, in particular, predetermined. This procedure can also be carried out for many machines or across machines. Preferably, the storage device is a cloud. Preferably, data is determined over a complete lifetime of a machine. This data can be used to predict an imminent failure of a valve, for example, using artificial intelligence (AI).

The present invention is further directed to an apparatus for forming plastic preforms into plastic containers. This has a transport device which transports the plastic preforms along a predetermined transport path. Furthermore, the device has an application device, such as a blow nozzle, which acts upon the plastic preforms with a flowable and, in particular, gaseous medium during this transport in order to expand them.

Furthermore, the device has a controllable valve which controls the pressurisation of the compressed air reservoir with the flowable medium, whereby a target pressure is specified with which the compressed air reservoir is pressurised. Furthermore, a control device takes this set pressure into account when controlling the valve or valves.

According to the invention, the device has at least one measuring device for determining an actual pressure and a comparison device compares this actual pressure with the target pressure. Furthermore, the processor device determines a correction value from this comparison, which is or can be taken into account in the control of the valve or valves.

It is therefore also suggested on the device side that pressures are determined and compared with target pressures and that correction values are determined from this. As mentioned above, the correction value can be a time value.

Preferably, the control device is suitable and intended to change a point in time of the activation of the valve of the reducing station in consideration of the correction value. In this embodiment, it is therefore proposed that a time at which the valve is switched, for example opened, is changed in particular in response to the correction value and thus also in response to the measured actual pressure.

Preferably, the device has a reducing station which is suitable and intended for reducing a pressure originating from a pressure source. It is also possible that this reducing station is also controlled by the control device and/or depending on the measured actual pressure. Preferably, the above-mentioned valve is a component of this reducing station.

The invention allows compensation for a (particularly long-term) change in control tolerances due to wear of the seals, for example. This no longer needs to be compensated for by a change in the bottle recipe. If the control tolerance changes in the short term, for example due to a rise in hall temperature, this is also compensated for automatically by the control system. Transferring bottle recipes from one machine to another is also made easier, since the deviations (behaviour) of the machines are automatically adjusted to each other. The operator has the impression that not only visually identical machines are being used, but also identical machines in terms of process technology.

Furthermore, intelligent control (AI) could be used to draw conclusions about service life, wear, process control and the like, and a possible process adjustment could be made to compensate for these deviations or tolerances.

This idea can be applied to any container handling machine, i.e. both rotary and indexing machines, in which compressed air is used to perform process steps or their functions.

In addition, the quality of the blown containers increases and the number of defective containers decreases. Furthermore, the material distribution can be controlled and/or influenced much better. A change in the necessary process pressure, for example due to wear of the seals, bottle bursting and also due to the decrease in the necessary air volume through the blowing process, is automatically compensated or reduced to a minimum and/or compensated for.

### BRIEF DESCRIPTION OF THE DRAWINGS

Further advantages and embodiments can be seen in the attached figure. Thereby shows:

FIG. 1 a schematic representation of an apparatus according to the invention.

### DETAILED DESCRIPTION OF THE DRAWINGS

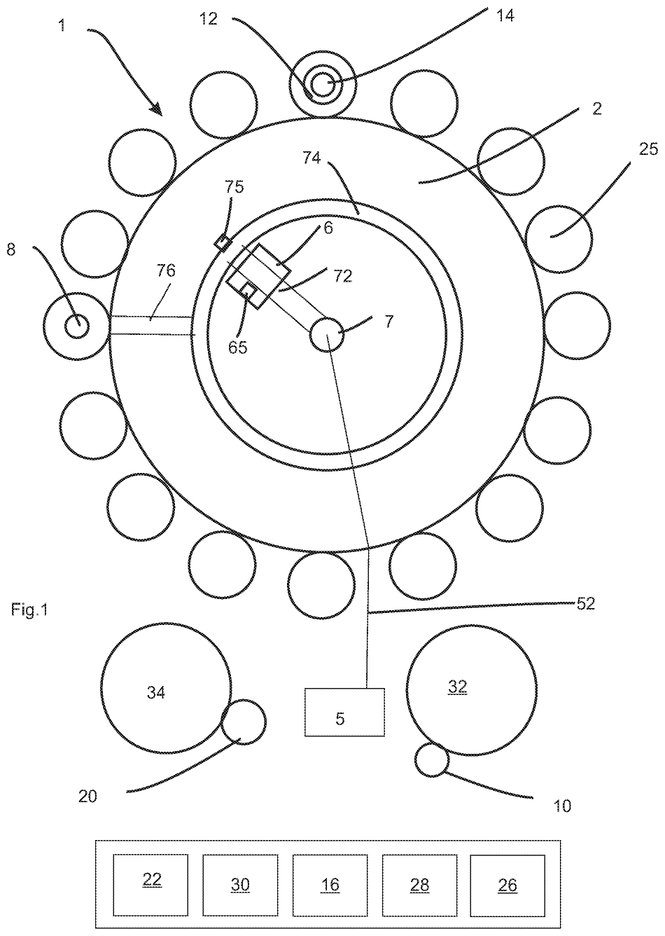

FIG. 1 shows a roughly schematic representation of an apparatus 1 according to the invention for forming plastic preforms 10 into plastic containers and in particular plastic bottles. In particular, the device is a stretch blow-moulding machine. The reference sign 2 indicates a transport device such as a so-called blowing wheel, on which a plurality of forming stations 25 are arranged. These forming stations are preferably designed in the same way or have the same components. For reasons of clarity, however, this is only shown for two forming stations.

The reference sign 32 indicates a feeding device such as a transport star which feeds plastic preforms 10 to the forming device 1 and the reference sign 34 indicates a removal device which removes the blown plastic containers from the forming apparatus 1.

The reference sign 5 indicates a source of compressed air, such as a compressor, which provides compressed air and supplies it to the device via a line 52. Reference sign 7 indicates a rotary distributor that ultimately distributes the supplied compressed air to the individual forming stations 25.

The reference sign 72 indicates a connection line which connects a compressed air reservoir such as an annular channel 74 with the rotary distributor. Preferably, the device has at least two, preferably at least three such annular channels. The reference sign 6 identifies a reducing station such as a dome pressure regulator which reduces the pressure coming from the compressed air source 5. The reference sign 65 indicates a valve of this reducing station. This valve is preferably controlled in the process according to the invention.

The forming stations each have a application device 14, such as a blow nozzle, which acts upon the plastic preforms with compressed air. The reference sign 12 schematically indicates a valve which controls the compressed air supply to the plastic preform 10.

The reference sign 8 roughly schematically identifies an (optionally available) measuring device, more precisely a pressure detection device, which detects the actual (air) pressure (in particular inside the containers to be expanded). The reference sign 75 indicates a pressure measuring device which is assigned to the annular channel 74 and which determines the pressure of the flowable medium within the annular channel 74.

By means of an input device 28, a user can preset a target pressure for the machine. A comparison device 22 compares the measured actual pressure (preferably separately and assignable for each forming station) with the target pressure and preferably determines a difference between these pressures.

A processor device 30 determines a correction value from this difference, which is used by a control device 16 to control the individual valves of the conversion stations.

Preferably, a memory device 26 is also provided, which stores the measured pressures, preferably with an assignment to the respective forming stations and preferably also with a time value, preferably for each individual forming station.

The reference sign 6 indicates (roughly schematically) reducing station such as a dome pressure regulator, which reduces the air pressure coming from the compressed air source 5.

The applicant reserves the right to claim all features disclosed in the application documents as essential to the invention, provided they are individually or in combination new compared to the prior art. It is further pointed out that the individual figures also describe features which may be advantageous in themselves. The skilled person immediately recognises that a certain feature described in a figure can also be advantageous without adopting further features from this figure. Furthermore, the skilled person recognises that advantages can also result from a combination of several features shown in individual figures or in different figures.

1. A method for forming plastic preforms into plastic containers, wherein the plastic preforms being transported along a predetermined transport path and being acted upon and expanded by a flowable medium during this transport, a controllable valve of a reducing station controlling the action of the flowable medium on a compressed-air reservoir, in particular on an annular channel, and a desired target pressure being predetermined, with which the compressed-air reservoir (74) is acted upon, this target pressure being taken into account in the control of the valve of the reducing station, wherein
an actual pressure is determined and this actual pressure is compared with the target pressure and, from this comparison, a correction value is determined which is taken into account and/or used in the control of the valve.

2. The method according to claim 1,
wherein
the correction value results from a difference between the actual pressure and the target pressure.

3. The method according to claim 1,
wherein,
taking into account the correction value, a time is determined at which the valve of the reducing station is actuated and, in particular, a time is determined at which the valve of the reducing station switches between an open position and a closed position.

4. The method according to claim 1,
wherein
a plurality of forming stations is provided for forming plastic preforms and an actual pressure is determined for each of these forming stations.

5. The method according to claim 1,
wherein
the plastic preforms are subjected to several pressure stages for expansion and preferably the actual pressure is determined for at least one of these pressure stages.

6. The method according to claim 1,
wherein
the valve of the reducing station is a proportional valve.

7. The method according to claim 1,
wherein
the pressurised flowable medium is made available via a source of compressed air and preferably the pressure originating from this source of compressed air is reduced by a reducing station before the compressed air enters the compressed air reservoir.

8. The method according to claim 1,
wherein
the actual pressure is determined using at least one pressure measuring device which is arranged in a compressed air reservoir and/or using a plurality of pressure measuring devices which are assigned to individual forming stations.

9. The method according to claim 1,
wherein
the actual pressure is continuously detected.

10. The method according to claim 1,
wherein
the actual pressures, target pressures and/or correction values are preferably continuously recorded using a storage device.

11. The method according to claim 1,
wherein
an artificial intelligence is used to determine characteristic values of the device.

12. An apparatus for forming plastic preforms into plastic containers, comprising a transport device which transports the plastic preforms along a predetermined transport path and an application device which acts upon the plastic preforms during this transport with a flowable medium in order to expand them, the apparatus having a controllable valve which controls the admission of the flowable medium to a compressed-air reservoir, in particular an annular channel, and it being possible to preset a desired target pressure with which the compressed-air reservoir is admitted, a control device taking account of this desired target pressure in the control of this valve,
wherein
the device has a measuring device for determining an actual pressure, and a comparison device compares this actual pressure with the target pressure, and a processor device uses this comparison to determine a correction value which is taken into account in the control of the valve.

13. The apparatus according to claim 12,
wherein
the control device is adapted and designed to change a timing of the actuation of the valve of the reducing station taking into account the correction value.

14. A device according to claim 12,
wherein
the device comprises a reducing station which is configured for reducing a pressure originating from a pressure source and the valve is preferably a component of this reducing station.
